(19) United States
(12) Patent Application Publication
(10) Pub. No.: US 2018/0234261 A1
(43) Pub. Date: Aug. 16, 2018

(54) PERSONALIZED SERVICE METHOD AND DEVICE

(71) Applicant: Samsung Electronics Co., Ltd., Suwon-si (KR)

(72) Inventors: Junhwi CHOI, Seongnam-si (KR); Chilhee CHUNG, Seoul (KR); Hodong LEE, Yongin-si (KR); Hoshik LEE, Seongnam-si (KR)

(73) Assignee: Samsung Electronics Co., Ltd., Suwon-si (KR)

(21) Appl. No.: 15/711,827

(22) Filed: Sep. 21, 2017

(30) Foreign Application Priority Data
Feb. 14, 2017 (KR) 10-2017-0019834
Apr. 11, 2017 (KR) 10-2017-0046534

(51) Int. Cl. H04L 12/28; H04W 4/00; G06F 3/16

(52) U.S. Cl. CPC H04L 12/2829; G06F 3/167; H04W 4/005; H04L 12/282

(57) ABSTRACT

A processor implemented operating method of a mobile device includes: verifying whether the mobile device is docked with a docking device while the mobile device is performing a personal assistance service (PAS); and continuously providing the PAS being performed using the docking device in response to the verifying indicating that the mobile device is docked with the docking device while the mobile device is performing the PAS.

### CROSS-REFERENCE TO RELATED APPLICATIONS

This application claims the benefit under 35 USC § 119(a) of Korean Patent Application No. 10-2017-0019834 filed on Feb. 14, 2017, and Korean Patent Application No. 10-2017-0046534 filed on Apr. 11, 2017, in the Korean Intellectual Property Office, the entire disclosures of which are incorporated herein by reference for all purposes.

### BACKGROUND

### 1. Field

The following description relates to a mobile device for providing a personalized service, and operating methods thereof.

### 2. Description of Related Art

Various electronic products are easily operated and controlled through the Internet of things (IoT) technology. A separate control device is provided in an IoT device and/or other electronic devices to provide a user customized service through the IoT. For example, a dedicated control device for a smart phone is provided in a smart phone, and a dedicated control device for a smart TV is provided in a smart TV.

### SUMMARY

This Summary is provided to introduce a selection of concepts in a simplified form that are further described below in the Detailed Description. This Summary is not intended to identify key features or essential features of the claimed subject matter, nor is the Summary intended to be used as an aid in determining the scope of the claimed subject matter.

In one general aspect, there is provided a processor implemented operating method of a mobile device, the operating method including: verifying whether the mobile device is docked with a docking device while the mobile device is performing a personal assistance service (PAS); and continuously providing the PAS being performed using the docking device in response to the verifying indicating that the mobile device is docked with the docking device while the mobile device is performing the PAS.

The PAS may include any one or any combination of any two or more of viewing, listening to, subscribing, searching, and recommending information; and the information may include any one or any combination of any two or more of weather and news, scheduling, making a call, recommending personalized content, importing personal settings, listening to voice information including a sound source, and object control.

The continuously providing the PAS being performed may include using an input/output interface of the docking device or an input/output interface of another device controlled by the docking device.

The operating method may further include: providing the PAS in a first manner in response to the verifying indicating that the mobile device is not docked with the docking device, wherein the continuously providing of the PAS being performed may include providing the PAS in a second manner different from the first manner while maintaining continuity of the PAS in response to the verifying indicating that the mobile device is docked with the docking device while the mobile device is performing the PAS.

The operating method of may further include: providing the PAS based on a hardware performance of the mobile device in response to the verifying indicating that the mobile device is not docked with the docking device while the mobile device is performing the PAS, wherein the continuously providing of the PAS being performed may include: identifying a hardware performance of the docking device or another device controlled by the docking device, changing a quality of the PAS based on the hardware performance of the docking device or the other device controlled by the docking device, and providing the quality-changed PAS while maintaining continuity of the PAS.

In another general aspect, there is provided a processor implemented operating method of a docking device, the operating method including: verifying whether a mobile device is docked with the docking device; and continuously providing a personal assistance service (PAS) being performed by the mobile device in response to the verifying indicating that the mobile device is docked with the docking device.

The continuously providing may include providing the PAS through at least one function included in the docking device; and the PAS was provided through at least one function included in the mobile device before docking with the docking device.

The continuously providing may include: receiving user information related to a user of the mobile device from the mobile device; and providing the PAS based on the user information.

The user information may include any one or any combination of any two or more of a language used by the user, personal information of the user, a use pattern of the user in the mobile device corresponding to an input of the user, setting information of the mobile device, preference information of the user, vocal characteristic information of the user, and image characteristic information of the user.

The continuously providing may include: receiving vocal characteristic information of a user of the mobile device from the mobile device; performing voice recognition with respect to a received voice based on the vocal characteristic information; and continuously providing the PAS based on a result of the voice recognition.

The performing may include analyzing, based on the vocal characteristic information, whether the received voice is to request the PAS; and the PAS was provided by the mobile device before docking with the docking device.

The continuously providing may include providing, in response to the analyzing determining that the received voice is to request a news viewing service, the news viewing service through at least one function included in the docking device; and the news viewing service was provided by the mobile device before the mobile device was docked with the docking device.

The continuously providing may include: verifying, in response to the analyzing determining that the received voice is to request a news viewing service, whether the news viewing service is providable through at least one function included in the docking device, and providing a news listening service in response to the verifying indicating that the news viewing service is not providable through the at least one function included in the docking device; and the news viewing service was provided by the mobile device before docking with the docking device.

The operating method may further include receiving setting information of the mobile device from the mobile device, wherein the continuously providing may include: adjusting, in response to the analyzing determining that the received voice is to request the PAS, settings for the docking device to correspond to the setting information of the mobile device, and providing the PAS based on the adjusted settings for the docking device, and wherein the PAS was provided by the mobile device before docking with the docking device.

The continuously providing may include: receiving food preference information of a user of the mobile device from the mobile device; processing information related to food stored in a food storage linked with the docking device based on the food preference information of the user of the mobile device; and providing the processed information to the user.

In another general aspect, there is provided a processor implemented operating method of a smart device, the operating method including: receiving an input; verifying whether a mobile device is connected to the smart device; determining, based on a result of the verifying, a server to access to analyze the input; and transmitting the input to the determined server.

The receiving may include either one or both of: receiving the input through an interface of the smart device; and receiving the input from a small device connected to the smart device.

The input may include any one or any combination of any two or more of a voice input, a gesture input, a motion input, an image input, and a touch input.

The smart device may be one or more smart devices that may include any one or any combination of any two or more of a home appliance, an audio system, a speaker, a robot vacuum cleaner, a personal service robot, a portable communication device, a dock, and an automobile.

The determining may include: determining, in response to the verifying indicating that the mobile device is not connected to the smart device, a first server corresponding to the smart device to be the server to access; and determining, in response to the verifying indicating that the mobile device is connected to the smart device, a second server corresponding to the mobile device to be the server to access.

The smart device may be installed in a space for a predetermined user; and the first server may be configured to be set as a server corresponding to the space for the predetermined user, and analyze the input to provide a personalized service to the predetermined user.

The smart device may be installed in a space for a predetermined user; and the first server may be configured to be set as a server corresponding to the space for the predetermined user, and analyze the input to provide a common service in the space.

The second server may be configured to analyze the input to provide a personalized service to a user of the mobile device.

The personalized service may include any one or any combination of any two or more of a language used by the user, personal information of the user, a use pattern of the user with respect to a target device to be controlled that corresponds to the input, setting information of the target device, and preferred content of the user.

The verifying may include either one or both of: verifying whether there is a mobile device connected to the smart device through wired docking; and verifying whether there is a mobile device connected to the smart device through wireless pairing.

The operating method of claim 16, wherein the server may be configured to:

determine a target device to be controlled that corresponds to the input by analyzing the input based on a corresponding database; and generate a first command to control the target device.

The verifying may include verifying whether the mobile device is connected with the smart device while the mobile device is performing a personal assistance service (PAS); and the PAS being performed is continuously provided using the smart device in response to the verifying indicating that the mobile device is connected with the smart device.

The server may be configured to: determine a feedback device based on a result of executing the first command; and generate a second command for a feedback through the feedback device.

The operating method may further include activating, in response to the verifying indicating that the mobile device is connected to the smart device, a small device operating in a sleep mode and connected to the smart device.

In another general aspect, there is provided processor implemented operating method of a smart device, the operating method including: receiving a second command from a second server corresponding to a user of a mobile device; verifying whether the user has an authority over the second command using a memory of the smart device or the first server; and executing the second command based on a result of the verifying, wherein the second command is different than a first command from a first server corresponding to the smart device for execution of the first command by the smart device.

The first server corresponds to a space in which the smart device is installed, and the second server corresponds to the user of the mobile device.

The second command may include a second control command determined by the second server in response to an input of the user, and the second control command may include at least one of a control command to control the smart device or a control command to control a small device connected to the smart device.

The operating method may further included feeding back a result of executing the second command to the second server.

The second command may include a second feedback command determined by the second server based on a result of executing a control command corresponding to an input of the user, and the second feedback command may include at least one of a feedback command for a feedback through the smart device or a feedback command for a feedback through a small device connected to the smart device.

In another general aspect, there is provided a non-transitory computer-readable medium storing instructions that, when executed by a processor, cause the processor to perform one or more or all methods and processes described herein.

Other features and aspects will be apparent from the following detailed description, the drawings, and the claims.

### BRIEF DESCRIPTION OF THE DRAWINGS

FIG. 1 is a diagram illustrating an example of an environment in which a personalized service is provided in accordance with an embodiment.

FIG. 2 is a flowchart illustrating an example of an operating method of a mobile device to provide a personalized service in accordance with an embodiment.

FIG. 3 is a flowchart illustrating an example of an operating method of a docking device to provide a personalized service in accordance with an embodiment.

FIG. 4 is a diagram illustrating an example of a configuration of a system for providing a personalized service in accordance with an embodiment.

FIG. 5 is a block diagram illustrating an example of an operation of a server to provide a personalized service in accordance with an embodiment.

FIG. 6 is a block diagram illustrating an example of an operation between elements of a system for providing a personalized service in accordance with an embodiment.

FIG. 7 is a diagram illustrating an example of a process in which a server provides a personalized service to a user in accordance with an embodiment.

FIG. 8 is a block diagram illustrating an example of a smart device in accordance with an embodiment.

FIGS. 9A, 9B, and 9C illustrate examples of scenarios in which a smart device determines a server to access in accordance with an embodiment.

FIGS. 10A, 10B, and 100 illustrate examples of various scenarios in which a smart device executes a command from a server in accordance with an embodiment.

FIG. 11 is a diagram illustrating an example of a method of feeding back a result of executing a control command for each user by a smart device in accordance with an embodiment.

FIGS. 12 and 13 are flowcharts illustrating examples of an operating method of a smart device in accordance with an embodiment.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Various alterations and modifications may be made to the examples. Here, the examples are not construed as limited to the disclosure and should be understood to include all changes, equivalents, and replacements within the idea and the technical scope of the disclosure.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Terms such as A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof, nor the lack of such stated features, numbers, operations, members, elements, and/or combinations thereof in further alternative embodiments unless the context and understanding of the present disclosure indicates otherwise. In addition, the use of the term “may” herein with respect to an example or embodiment, e.g., as to what an example or embodiment may include or implement, means that at least one example or embodiment exists where such a feature is included or implemented while all examples and embodiments are not limited thereto.

The features of the examples described herein may be combined in various ways as will be apparent after an understanding of the disclosure of this application. Further, although the examples described herein have a variety of configurations, other configurations are possible as will be apparent after an understanding of the disclosure of this application.

Unless otherwise defined, all terms including technical and scientific terms used herein have the same meaning as commonly understood by one of ordinary skill in the art to which examples belong, in view of the present disclosure. It will be further understood that terms, such as those defined in commonly-used dictionaries, should be interpreted as having a meaning that is consistent with their meaning in the context of the relevant art and the present disclosure, and will not be interpreted in an idealized or overly formal sense unless expressly so defined herein.

When describing the examples with reference to the accompanying drawings, like reference numerals refer to like constituent elements and a repeated description related thereto will be omitted. When it is determined detailed description related to a related known function or configuration they may make the purpose of the examples unnecessarily ambiguous in describing the examples, the detailed description will be omitted here.

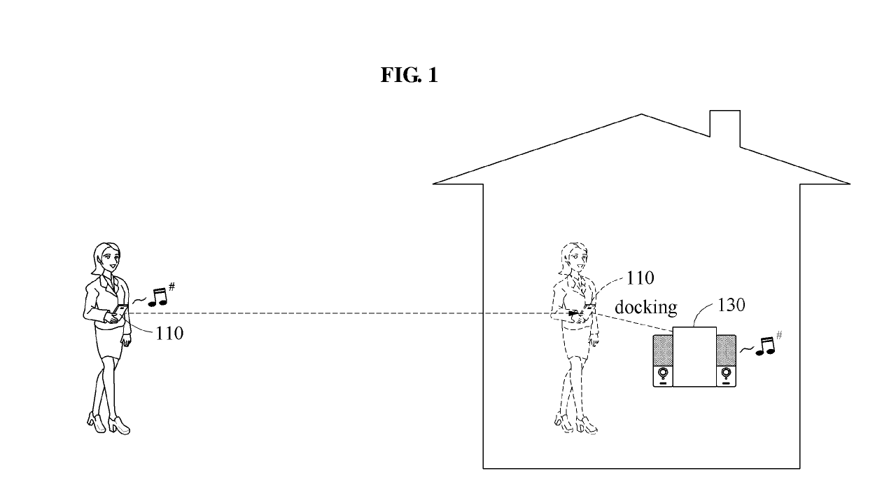

FIG. 1 is a diagram illustrating an example of an environment in which a personalized service is provided in accordance with an embodiment. Referring to FIG. 1, a mobile device 110, and a docking device 130 with which the mobile device 110 is to be docked are illustrated.

The mobile device 110 includes at least one processor configured to provide a personal assistant service (PAS), a communication interface configured to perform communication including data transmission and reception, and a memory.

Applications, commands, or programs are provided in the mobile device 110 to provide the PAS. Here, the “PAS” refers to a service that analyzes an input of a user, for example, a voice, a gesture, a motion, a captured image, or a screen touch of the user, executes an instruction from the user based on a result of the analysis, and learns a habit or a behavior pattern of the user, thereby providing a customized service required by the user like a personal assistant.

The PAS includes, for example, viewing, listening to, subscribing, searching, or recommending information including weather and news, scheduling, making a call, recommending personalized content, importing personal settings, listening to voice information including a sound source, or controlling an object. Here, the object is an electronic device connected to the mobile device 110 in a wired or wireless manner.

The PAS is provided based on user information, for example, a language used by the user, personal information of the user, a use pattern of the user in the mobile device 110 corresponding to an input of the user, setting information of the mobile device 110, preference information of the user, vocal characteristic information of the user, or image characteristic information of the user.

The personal information of the user may include, for example, an age, a gender, a family member, a hobby, an occupation, and/or an educational background of the user.

The use pattern of the user in the mobile device 110 corresponding to the input of the user is a use pattern of the user in the mobile device 110 that is verified based on a continuous use of the user. The use pattern of the user in the mobile device 110 corresponding to the input of the user may include, for example, a use pattern to execute a predetermined application in the mobile device 110 in response to a predetermined voice input of the user (for example, “Agoda”), a use pattern to capture the user in the mobile device 110 in response to a predetermined gesture input of the user (for example, a gesture of making a V sign with fingers), a use pattern to provide predetermined content or execute a predetermined command using the mobile device 110 in response to image characteristic information (for example, a smiling or frowning face of the user captured through a camera or vision sensor), and/or a use pattern to play predetermined music in the mobile device 110 in response to a touch input of a predetermined form through a touch display of the mobile device 110.

The setting information of the mobile device 110 may include, for example, hardware setting information of the mobile device 110 (such as a volume and sound of a speaker), a resolution and brightness of the display (or a processing rate of the processor), and/or processor-executed instructions stored on a non-transitory computer readable medium of the mobile device 110 (such as a blocked application, an installed application, language settings, country settings, or an alarm set time).

The preference information of the user may include, for example, a preference for a music channel, a preference for a news channel, a preference for a movie genre, a preference for a food, and/or a preference for an exercise and hobby. Further, the vocal characteristic information of the user may include, for example, a tone of voice of the user, a pitch of voice of the user, an accent of the user, a lenition of the user, a speech tempo of the user, and/or a volume of the user. The image characteristic information of the user may include, for example, a static or dynamic face image of the user, various facial expressions of the user, a fingerprint of the user, and/or an image of a body part of the user (such as an eye or a mouth of the user).

The aforementioned examples of the user information are provided exemplarily. However, embodiments are not limited thereto, and the user information may include a variety of information.

The user information for the PAS is stored in, for example, the memory of the mobile device 110 or a separate storage device.

The mobile device 110 performs, for example, natural language recognition, sentence analysis, image recognition, and/or situation recognition. The mobile device 110 may include a communication function like, for example, a tablet computer, a smart phone, a personal digital assistant (PDA), a wearable device, and/or other mobile devices, and may be implemented by various communication devices that may be carried by the user.

In an embodiment, the mobile device 110 is docked with the docking device 130. Herein, “docking” and “docked” means that the mobile device 110 is coupled with the docking device 130 through either one or both of physical contact or wireless connection (such as wireless docking or wireless pairing).

The docking device 130 provides the same PAS provided by the mobile device 110 through contact or fastening with the mobile device 110. The docking device 130 may include a contact portion or fastening portion to be in contact with or to be fastened with the mobile device 110.

The docking device 130 may include any type of electronic device including a contact portion or fastening portion to be in contact with or to be fastened with the mobile device 110. For example, the docking device 130 may include a home appliance, an audio system, a speaker, a robot vacuum cleaner, a personal service robot, a portable communication device, a dock, and/or an automobile.

The mobile device 110 performs the PAS directly. The mobile device 110 continuously provides the PAS through an input/output interface of the docking device 130 with which the mobile device 110 is docked or an input/output interface of another device controlled by the docking device 130.

For example, it may be assumed that the user is on the way home while being provided with a PAS through the mobile device 110. In this example, the PAS is a service that provides a news channel or music channel preferred by the user.

If the user desires to continuously listen to the news channel or music channel even after getting home, the user docks the mobile device 110 with the docking device 130 installed in a house of the user.

The mobile device 110 verifies whether the mobile device 110 is docked with the docking device 130 while providing the news channel or music channel preferred by the user. In response to verification that the mobile device 110 is docked with the docking device 130, the mobile device 110 provides the news channel or music channel being provided by the mobile device 110 using the docking device 130. The PAS being provided by the mobile device 110 is continuously provided by the docking device 130 through docking.

Here, that the PAS is “continuously” provided indicates that the service being provided or performed through at least one function included in the mobile device 110 before docking with the docking device 130 is provided identically through at least one function included in the docking device 130 after docking. For example, when the PAS being provided or performed by the mobile device 110 before docking between the mobile device 110 and the docking device 130 corresponds to a service A, the same service A is provided or performed through the docking device 130 after docking between the mobile device 110 and the docking device 130. In this example, the service A is provided constantly, that is, seamlessly, in the docking process.

For example, it may be assumed that the user is on the way home while being provided with a news channel B through the mobile device 110.

The user gets home, docks the mobile device 110 with the docking device 130, and says “Show me the news channel B that I watched just before”. The mobile device 110 docked with the docking device 130 analyzes the speech “Show me the news channel B that I watched just before” received from the user based on pre-stored vocal characteristic information of the user. In this example, the mobile device 110 analyzes whether the received speech is to request a viewing service of the news channel B provided by the mobile device 110 before docking with the docking device 130. In response to analyzing that the speech is to request the viewing service of the news channel B, the mobile device 110 provides the viewing service of the news channel B through the docking device 130 based on a result of the analyzing.

In an example, in response to analyzing that the received speech is to request a news viewing service provided by the mobile device 110 before docking with the docking device 130, the docking device 130 verifies whether the news viewing service is providable through at least one function included in the docking device 130. In this example, in response to verification that the news viewing service is not providable since the docking device 130 includes only a speaker and does not include a display to provide a news viewing service, the docking device 130 provides a news listening service which is similar to the news viewing service, instead of the news viewing service.

In an example, the docking device 130 receives the vocal characteristic information of the user of the mobile device 110 from the mobile device 110 docked with the docking device 130, and performs speech recognition with respect to the received speech “Show me the news channel B that I watched just before” based on the vocal characteristic information. In response to analyzing that the received speech is to request the news channel B provided by the mobile device 110 before docking with the docking device 130, the docking device 130 continuously provides the news channel B.

Furthermore, the user may say “Keep playing music C that I'm listening to now at home” on the way home. The mobile device 110 analyzes and/or recognizes the speech “Keep playing music C that I'm listening to now at home” based on the pre-stored vocal characteristic information of the user. The mobile device 110 discerns, based on a result of the speech analysis, that the corresponding speech is to request continuous provision of the music C provided by the mobile device 110 before docking between the mobile device 110 and the docking device 130, even after docking between the mobile device 110 and the docking device 130. When the user gets home and docks the mobile device 110 with the docking device 130, the mobile device 110 provides the music C through the docking device 130.

The mobile device 110 provides the PAS in different manners based on whether the mobile device 110 is docked with the docking device 130 while performing the PAS.

The mobile device 110 provides the PAS in a first manner in response to verification that the mobile device 110 is not docked with the docking device 130. The mobile device 110 provides the PAS in a second manner different from the first manner while maintaining continuity of the PAS in response to verification that the mobile device 110 is docked with the docking device 130.

In this example, the first manner is a manner corresponding to a hardware performance of the mobile device 110 or at least one function included in the mobile device 110. The second manner is a manner corresponding to a hardware performance of the docking device 130 or the other device controlled by the docking device 130 or at least one function included in the docking device 130 or the other device.

For example, it may be assumed that the mobile device 110 is providing a PAS that provides an answer to a question of the user. In this example, it may also be assumed that the mobile device 110 includes a voice recognition function, a display function, and a speaker function, and the docking device 130 includes a voice recognition function and a speaker function.

In response to verification that the mobile device 110 is not docked with the docking device 130, the mobile device 110 provides the PAS in a manner that provides the answer in a form of image to be displayed on a display through the voice recognition function and the display function of the mobile device 110. In response to verification that the mobile device 110 is docked with the docking device 130, the mobile device 110 provides an answer in a form of voice, rather than being displayed on a display, through the docking device 130 while maintaining continuity of the PAS that provides the answer to the question of the user.

The docking device 130 detects a location of the user through the mobile device 110 and automatically performs local area wireless connection with the mobile device 110, thereby continuously providing the PAS being performed by the mobile device 110.

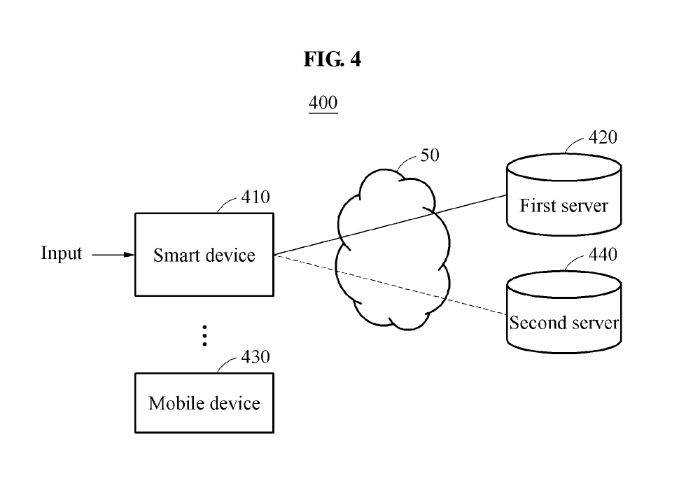

Further, the docking device 130 identifies the user of the mobile device 110 docked with the docking device 130, and provides the PAS to the identified user of the mobile device 110. Examples in which the docking device 130 identifies the user of the mobile device 110 and provides the PAS will be described further with reference to FIGS. 4 through 13.

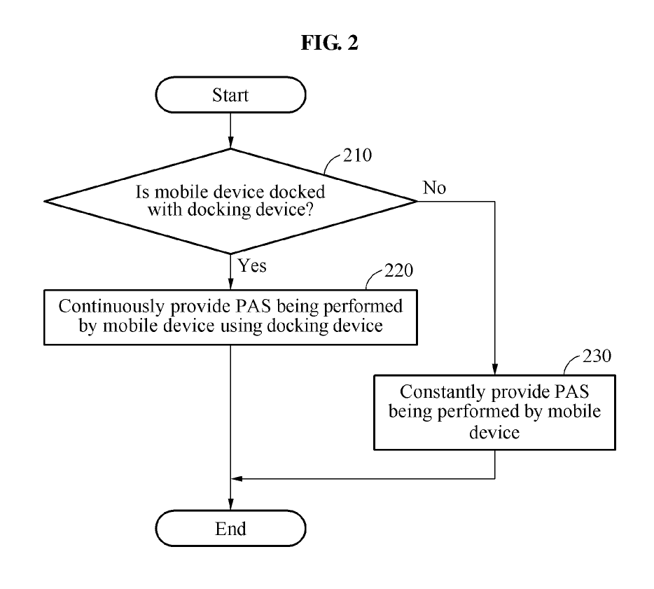

FIG. 2 is a flowchart illustrating an example of an operating method of a mobile device to provide a personalized service in accordance with an embodiment. Referring to FIG. 2, in operation 210, a mobile device verifies whether a mobile device is docked with a docking device while the mobile device is performing a PAS.

In response to verification that the mobile device is docked with the docking device while performing the PAS, the mobile device continuously provides the PAS being performed using the docking device, in operation 220. The mobile device continuously provides the PAS being performed using an input/output interface of the docking device or an input/output interface of another device controlled by the docking device.

For example, it may be assumed that the docking device is a home appliance, and a speaker is controlled by the home appliance. The mobile device continuously provides the PAS being performed through the docking device using an input/output interface of the home appliance or an input/output interface of the speaker.

In operation 220, the mobile device identifies a hardware performance of the docking device or a hardware performance of the other device controlled by the docking device. The other device is, for example, a television or a speaker. The mobile device identifies the hardware performance, for example, a processing rate, a memory capacity, a display resolution, a graphic card performance, or a speaker performance of the docking device or the other device. The mobile device changes a quality of the PAS based on the hardware performance of the docking device or the other device controlled by the docking device and provides the quality-changed PAS while maintaining continuity of the PAS.

The mobile device identifies the hardware performance of the docking device or the television, and provides the PAS by differently setting a quality of sound or a resolution of image based on the hardware performance of the docking device or the television.

In response to verification that the mobile device is not docked with the docking device while performing the PAS, the mobile device constantly provides the PAS being performed through the mobile device, in operation 230. Here, the mobile device provides the PAS by setting an optimized quality of sound or optimized resolution of image based on a hardware performance of the mobile device.

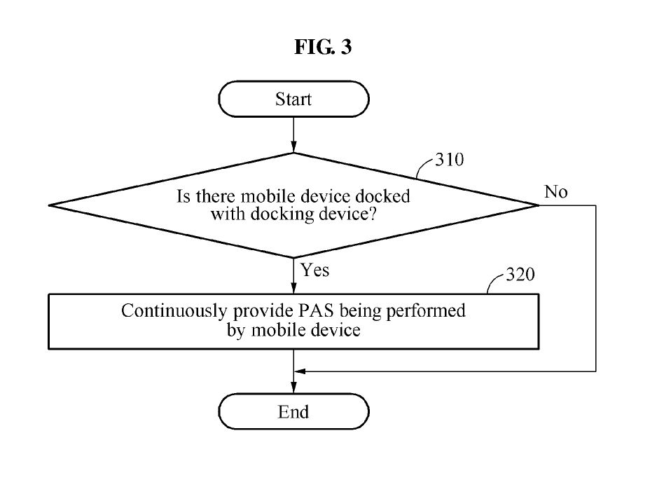

FIG. 3 is a flowchart illustrating an example of an operating method of a docking device to provide a personalized service in accordance with an embodiment. Referring to FIG. 3, in operation 310, a docking device verifies whether there is a mobile device docked with the docking device. In response to verification that there is not a mobile device docked with the docking device, the docking device terminates an operation.

In response to verification that there is a mobile device docked with the docking device, the docking device continuously provides a PAS being performed by the mobile device, in operation 320. In this example, the docking device receives user information related to a user of the mobile device docked with the docking device from the mobile device, and provides the PAS based on the user information.

For example, it may be assumed that a mobile device of a user A is docked with a speaker which is a docking device.

The docking device receives vocal characteristic information of the user A from the mobile device docked with the docking device. In this example, the vocal characteristic information of the user A is stored in the mobile device of the user A in advance. The docking device performs voice recognition with respect to a voice received by the docking device, for example, through a microphone of the docking device, based on the vocal characteristic information of the user A. Similarly, in a case in which a mobile device of a user B is docked with the docking device, the docking device performs voice recognition with respect to a voice received by the docking device based on vocal characteristic information of the user B that is received from the mobile device of the user B.

The docking device may be owned by the user A, the user B, or a user C or may be a shared device not owned by a predetermined user. The docking device provides a PAS to a user corresponding to user information received from a mobile device docked with the docking device, irrespective of an owner of the corresponding mobile device.

For example, it may be assumed that the docking device is a smart refrigerator, the mobile device is a smart phone of the user A, and food preference information of the user A indicating that the user A prefers strawberries and orange juice is stored in the smart phone of the user A.

The smart refrigerator receives the food preference information of the user A as user information from the smart phone of the user A docked with the smart refrigerator. The smart refrigerator processes information related to food stored in a food storage, for example, a storage compartment, of the smart refrigerator based on the food preference information of the user A. The smart refrigerator identifies a location of strawberries or orange juice that the user A prefers based on the information related to the food stored in the food storage, and provides a result of the identification, for example, the location of strawberries or orange juice, to the user A.

For example, it may be assumed that the docking device is an audio system, and the mobile device is a smart phone of the user B.

The audio system receives, from the smart phone of the user B docked with the audio system, vocal characteristic information of the user B and setting information of the smart phone of the user B.

The audio system being the docking device performs speech recognition with respect to a received speech “Play music that I listened to just before” based on the vocal characteristic information of the user B. In this example, it may be assumed that the received speech is analyzed to request a music listening service provided by the smart phone of the user B before docking between the audio system and the smart phone of the user B. The audio system adjusts settings of the audio system to correspond to setting information of the smart phone of the user B, for example, sound characteristic settings such as jazz, classic, or pop, volume settings, or sound pitch settings. The audio system provides the music listening service based on the adjusted settings.

FIG. 4 is a diagram illustrating an example of a configuration of a system for providing a personalized service in accordance with an embodiment. Referring to FIG. 4, a system 400 may include a smart device 410 and a first server 420. The system 400 further may include a mobile device 430 and a second server 440. The smart device 410, the first server 420, the mobile device 430, and the second server 440 communicate with each other through a network 50.

Hereinafter, the first server 420 is a server corresponding to the smart device 410, and the second server 440 is a server corresponding to the mobile device 430. The first server 420 is preset to correspond to the smart device 410. Further, the second server 440 corresponds to a user of the mobile device 430.

The network 50 may include, for example, the Internet, intranets, extranets, wide area networks (WANs), local area networks (LANs), wired networks, wireless networks, other suitable networks, or a predetermined combination of at least two of the aforementioned networks.

The smart device 410 may include a communication interface configured to interact with the first server 420. The smart device 410 receives an input from a user through an input interface. The input may include, for example, a voice input, a gesture input, a motion input, an image input, and/or a touch input. The smart device 410 may include, for example, a home appliance, an audio system speaker, a robot vacuum cleaner, a personal service robot, a portable communication device, a dock, or an automobile.

The smart device 410 verifies whether there is a mobile device 430 connected to the smart device 410. Here, the “connection” may include both connection by wired docking and connection by wireless pairing. In a case in which the mobile device 430 is connected to the smart device 410 by wired or wireless docking, the smart device 410 may be referred to as a “docking device”.

The mobile device 430 may include a communication function as described above, and may be implemented by various communication devices that may be carried by a user. The mobile device 430 is connected to the smart device 410 through, for example, wired docking or wireless pairing.

The smart device 410 determines a server to access to analyze the input based on, for example, whether there is a mobile device 430 connected to the smart device 410 and/or an owner of a mobile device 430 connected to the smart device 410.

The smart device 410 transmits the input of the user to the determined server.

In response to verification that there is not a mobile device 430 connected to the smart device 410, the smart device 410 determines the first server 420 preset to correspond to the smart device 410 to be the server to access, and transmits the input to the first server 420.

In an example, the first server 420 is a general-purposes server corresponding to a plurality of smart devices. In another example, the first server 420 is a server corresponding to a space in which the smart device 410 is installed or located and/or a user in the corresponding space. The first server 420 may include a database including information for providing a personalized server to a user corresponding to the smart device 410. The personalized service may include, for example, a language used by the user, personal information of the user, a use pattern of the user with respect to a target device to be controlled that corresponds to the input, setting information of the target device, or preferred content of the user.

In this example, the user in the space in which the smart device 410 is installed may be a predetermined user or an undetermined user. The predetermined user is a specified user, and the undetermined user is an unspecified user. For example, a user of a smart device installed in a house owned by an individual is a house owner corresponding to the predetermined user, and a user of a smart device installed in a hotel room is an unspecified guest corresponding to the undetermined user.

In a case in which the smart device 410 is installed in a space for a predetermined user, the first server 420 is set as a server corresponding to the space for the predetermined user. The first server 420 enables the smart device 410 to provide a personalized service to the predetermined user by analyzing the input transmitted through the smart device 410. Further, in a case in which the smart device 410 is installed in a space for an undetermined user, the first server 420 is set as a server corresponding to the space for the undetermined user. The first server 420 enables the smart device 410 to provide a common service in the space for the undetermined user by analyzing the input transmitted through the smart device 410.

In response to verification that there is a mobile device 430 connected to the smart device 410, the smart device 410 determines the second server 440 corresponding to the mobile device 430 to be the server to access, and transmits the input to the second server 440. In this example, the second server 440 provides a personalized service to the user of the mobile device 430 by analyzing the input.

The second server 440 is a server configured to provide the personalized service to the user of the mobile device 430. The second server 440 includes a database including information for providing the personalized server to the user of the mobile device 430.

The devices share information for providing a user customized service with each other through the second server 440. For example, when the user gets home and desires to search for music on the radio that the user heard during driving, the same information used by a vehicular control device provided in an automobile is used by a control device dedicated to a smart TV at home.

Further, other devices may be controlled through an interaction channel. In this example, a product developer may not need to develop a dedicated control device for each individual device, and a user may not need to set information separately so as to be provided with a customized service for each different device.

A user of the smart device 410 may be different from or the same as the user of the mobile device 430. For example, the user of the smart device 410 is a main user corresponding to the space in which the smart device 410 is installed, and may include, for example, an owner or a family member of the house in which the smart device 410 is installed. Hereinafter, the user of the smart device 410 will be referred to as a first user, and the user of the mobile device 430 will be referred to as a second user.

The first user of the smart device 410 is different from the second user of the mobile device 430. The first user corresponds to a user, an owner, or a manager who has a main authority for use over devices, for example, a smart device and a small device, included in the corresponding space. The second user is a user different from the first user, and corresponds to, for example, a customer or a guest who moves into a space for the first user. In this example, the first server 420 corresponding to the smart device 410 may be different from the second server 440 corresponding to the mobile device 430.

In a case in which the first user of the smart device 410 is the same as the second user of the mobile device 430, the first server 420 corresponding to the smart device 410 may be the same as the second server 440 corresponding to the mobile device 430. In a case in which the smart device 410 is used by a plurality of users, the user of the smart device 410 is determined to be the same as the user of the mobile device 430 when the user of the mobile device 430 is included in the users of the smart device 410.

Although the first user of the smart device 410 is the same as the second user of the mobile device 430, the first server 420 corresponding to the smart device 410 may be different from the second server 440 corresponding to the mobile device 430. For example, in a case in which the first server 420 is a general-purpose server and the second server 440 is a server corresponding to a user, the smart device 410 transmits the input to the general-purpose server or the server corresponding to the user based on whether the mobile device 430 is connected to the smart device 410.

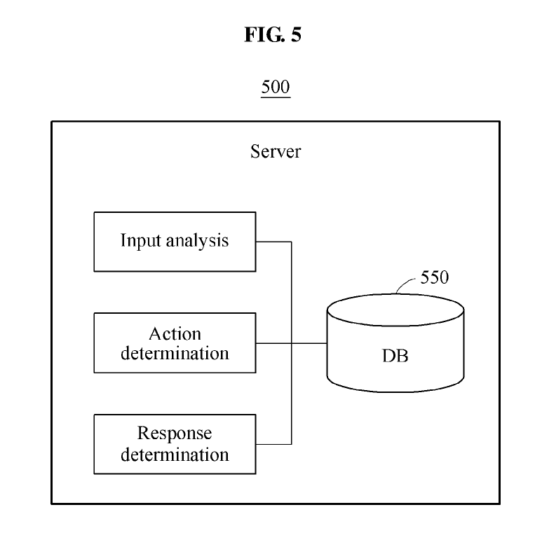

The first server 420 and/or the second server 440 may be, for example, an artificial personal assistant (APA) server. An operation of a server will be described in detail with reference to FIG. 5.

The smart device 410 operates as a target device to be controlled to perform a command of the first server 420 or the second server 440. For example, in a case in which the smart device 410 operates as the target device, the smart device 410 operates based on a command received from the first server 420 or the second server 440. In this example, the command received from the first server 420 or the second server 440 corresponds to a command to provide a personalized service to the first user or the second user. The smart device 410 also operates as a feedback device configured to feed back a result of executing the command of the first server 420 or the second server 440 to the first user or the second user.

The smart device 410 operates as a smart dock to be connected to a small device. For example, in a case in which the smart device 410 operates as the smart dock, the smart device 410 receives an input of the user provided through the small device and transmits the input to the first server 420 or the second server 440. Further, the smart device 410 controls the operation of the small device connected to the smart device 410 based on the command received from the first server 420 or the second server 440.

FIG. 5 is a block diagram illustrating an example of an operation of a server to provide a personalized service in accordance with an embodiment. Referring to FIG. 5, a server 500 receives an input from a connected device, for example, a smart device, a smart dock, or a mobile device, through a network. The input may include an input of a user provided or transmitted through the corresponding device and identification information, for example, an identification (ID), of the corresponding device.

The server 500 determines an action and a response suitable for the input by analyzing the input. Here, the “action” is for a target device to be controlled, that is, a target to execute a command. The target device may include, for example, a target device that is determined to execute a control command corresponding to an input and the target device. The “response” is for a feedback device configured to provide a feedback such that a user may check a result of executing a command using the target device. The feedback device may include, for example, a feedback device determined to execute a feedback command corresponding to the feedback device. A single feedback device or a plurality of feedback devices may receive the response from the server 500 based on a type of a feedback to be provided to the user.

The target device may be the same as or different from the feedback device.

The server 500 may include an input analyzer, an action determiner, and a response determiner.

The input analyzer performs an input analysis to analyze an input of a user received from the smart device. The action determiner performs an action determination to determine an action for the target device based on a result of analyzing the input of the user. The response determiner performs a response determination to determine a feedback in a suitable form based on a result of performing the action for the target device.

The input analyzer performs the input analysis based on a form of the input. As described above, the input is provided in a form of a voice input, a gesture input, a motion input, an image input, or a touch input.

For example, it may be assumed that the user inputs a speech using a smart phone. The input analyzer analyzes the speech using a speech recognizer and a translator. The input analyzer converts a result of analyzing the speech into command(s) or frame(s) that an electronic device may understand.

The input analyzer performs user authentication. For example, the input analyzer performs the user authentication by verifying whether the received input corresponds to an input of a user corresponding to the server 500. In this example, the input analyzer selectively processes an input with respect to which the user authentication succeeds.

The action determiner determines an action based on the command received from the input analyzer. The action determiner determines the action based on a device list of devices connected to a server determined by the input analyzer, for example, a server corresponding to a user A, and a command list of commands that may be executed by a connected device. The device list may include, for example, physical devices such as a smart TV and a radio, and devices configured to manage a schedule of the user. In this example, the device list and the command list are stored in a database 550 of the corresponding server 500. The database 550 also may include information related to an authority assigned to each user with respect to the device list and/or the command list. In addition, the database 550 may include a variety of information for a personalized service of the user corresponding to the server 500.

As shown in FIG. 5, the database 550 is included in the server 500. In another example, the database 550 may be positioned separately outside of the server 500, and connected to the server 500 in a wired or wireless manner. At least a portion of the database 550 may be provided in a mobile device, a smart device, or a smart dock.

The action determiner determines, based on the device list and the command list, a target device to perform a command (that is, a target device to be controlled) and a control command with respect to the target device. The action determiner also processes an input that is not expressly provided by a user (for example, a small talk or ambient noise other than a voice of the user corresponding to the input) to control a predetermined device.

The action determiner determines the action based on rules, or by machine learning. The action determiner determines a plurality of actions in response to a single input.

The response determiner determines a feedback device based on a result of executing the corresponding command by the target device, irrespective of the action, and determines all types of responses including commands for a feedback through the feedback device.

If the response is an actual command execution that the user desires to perform using a system, the response is a feedback of the system to inform the user of a result of the commend execution.

For example, if a natural language speech is received as the input, the response determiner determines to provide a feedback to the user through a smart device having transmitted the natural language speech in response to the natural language speech. The response determiner determines to provide a feedback to the user through flickering of a light emitting diode (LED) of a small device connected to a smart device other than the smart device having transmitted the natural language speech.

In a case in which the feedback is provided using a natural language speech, the response determiner provides a feedback to report a result of performing the action, and a feedback of a response to a question such as responding with small talk. In this example, the response determiner may include, for example, a natural language chatbot.

The response determiner determines the response based on the action of the action determiner, the result of the input analyzer, and an input from an input device. The response may include, for example, a plurality of feedback commands with respect to a plurality of feedback devices.

The server 500 is personalized based on, for example, a language used by the user, personal information of the user, a use pattern of the user with respect to the target device, setting information of the target device, and/or preferred content of the user. Further, the server 500 is personalized based on personalization information of the user, for example, improvement of user recognition performance based on a continuous use of the user, content recommendation customized for the user, and/or user schedule management, thereby increasing a user convenience.

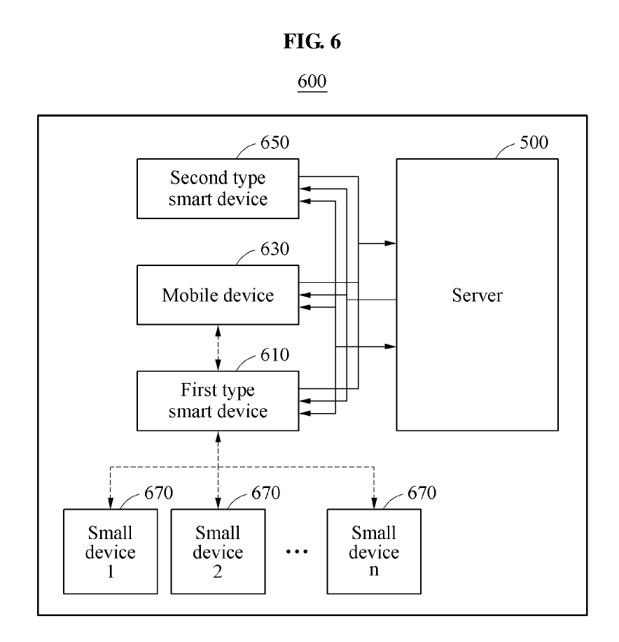

FIG. 6 is a block diagram illustrating an example of an operation between elements of a system for providing a personalized service in accordance with an embodiment. Referring to FIG. 6, a system 600 may include the server 500, a first type smart device 610, a mobile device 630, a second type smart device 650, and small device(s) 670. In FIG. 6, connections for direct communication with the server 500 are indicated using solid lines, and the other connections are indicated using broken lines.

Smart devices are devices connected directly to the server 500, except for the mobile device 630. The smart devices are divided into the first type smart device 610 that operates as a smart dock, and the second type smart device 650 other than the first type smart device 610.

The first type smart device 610 is connected to small device(s) 670, that may not be connected directly to the server 500 through local area wireless communication and/or wired communication, to manage and control operations of the small device(s) 670. For example, the first type smart device 610 transmits an input, a control command, and/or a feedback command between the small device(s) 670 and the server 500.

The small device(s) 670 are device(s) not including a wireless communication module or a communication interface configured to communicate directly with the server 500, and include, for example, a mini speaker, an IoT outlet, and a smart light. The small device(s) 670 are connected to the first type smart device 610 by local area wireless communication and/or wired communication, and communicate with the server 500 through the first type smart device 610. The small device(s) 670 are controlled through communication with the first type smart device 610.

As described above, the first type smart device 610 and the second type smart device 650 each determine a server 500 to access based on whether each is connected to the mobile device 630.

The first type smart device 610 and/or the second type smart device 650 detects a location of the user through local area wireless communication and/or wired communication with the mobile device 630, thereby helping with an operation of the server 500.

For example, when a user carrying the mobile device 630 comes into a house, the mobile device 630 and the first type smart device 610 are connected to each other through communication with each other, and thus the first type smart device 610 is activated. The first type smart device 610 is also activated based on a location of the user detected through the mobile device 630.

The small device(s) 670 connected to the first type smart device 610 operate in a sleep mode in which power consumption is at a minimum, and are activated in response to the connection between the first type smart device 610 and the mobile device 630.

The server 500 stores devices connected to the server 500, commands executable by the connected devices, and state information of the connected devices. In response to reporting changes in the states of the device(s) connected to the server 500, the server 500 updates state information based on the changes and determines an action and a response based on the updated state information.

The first type smart device 610 and the second type smart device 650 enroll a main user at the server 500, and set authorities for users other than the main user.

For example, it may be assumed that the first type smart device 610 and the second type smart device 650 are smart devices installed in a house of a user A, and the mobile device 630 is a mobile device of a user B who visits the house of the user A. When the mobile device 630 is connected to the first type smart device 610, the first type smart device 610 transmits an input to a server corresponding to the user B, instead of a server corresponding to the user A, thereby providing a personalized service to the user B.

In this example, the server corresponding to the user B transmits a control command to the second type smart device 650 as an action with respect to the input. The second type smart device 650 recognizes that the received control command is a command corresponding to a user other than the main user, and determines whether to execute the corresponding command based on an authority set by the main user. Thus, the user B is provided with a personalized service in a space for others. However, a range of the provided service is limited within a range allowed by the main user of the corresponding space.

The first type smart device 610 and the second type smart device 650 may be smart devices installed in the house of the user A, and the mobile device 630 is also a mobile device of the user A.

In this example, when the mobile device 630 is connected to the first type smart device 610, the first type smart device 610 transmits the input to the server corresponding to the user A, thereby providing a personalized service to the user A. The server corresponding to the user A is, for example, the server 500. The server 500 is the mobile device 630 itself, or at least a portion of the server 500 is included in the mobile device 630, or the server 500 is different from the mobile device 630.

In this example, the server corresponding to the user A transmits a control command to the second type smart device 650 as an action with respect to the input. The second type smart device 650 recognizes that the received control command is a command corresponding to the main user A, and determines whether to execute the corresponding command based on the authority set by the main user A. Thus, the user A is provided with a personalized service.

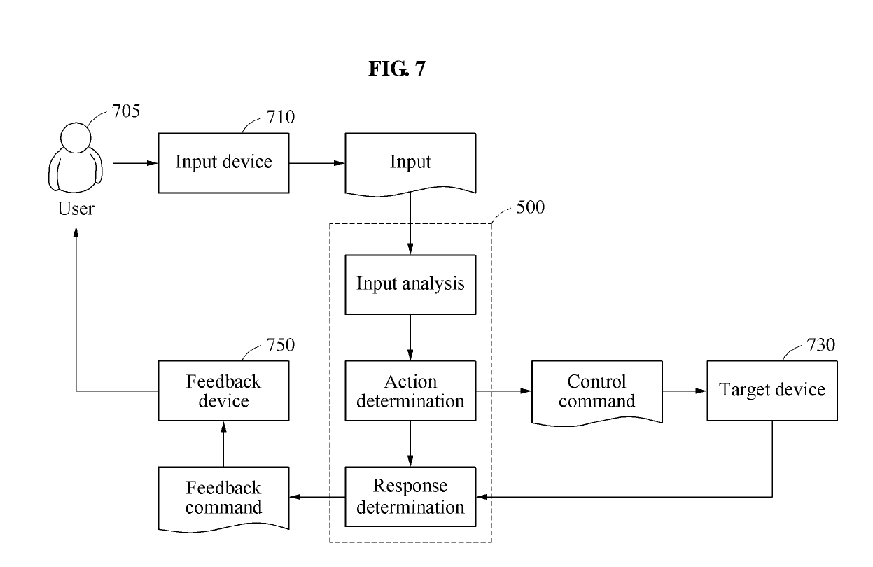

FIG. 7 is a diagram illustrating an example of a process in which a server provides a personalized service to a user in accordance with an embodiment. Referring to FIG. 7, a process of performing an action and a response corresponding to an input of a user 705 in response to the input being transmitted to the server 500 through an input device 710 is illustrated.

When the input of the user 705 is received from the input device 710, the server 500 analyzes the input of the user 705, and determines an action. The action is transmitted to a target device 730 to be controlled such that the target device 730 executes a control command. In this example, in relation to the execution of the control command at the target device 730, if there is content to be fed back to the user 705, the server 500 determines a response with respect to a result of executing the control command.

The server 500 generates a response including a feedback command based on the input of the user 705, a result of analyzing the input, and a result of executing the control command by the target device 730. The server 500 feeds back the response to the user 705 through a feedback device 750.

The input device 710, the target device 730, and the feedback device 750 may be the same device or different devices. For example, at least two of the input device 710, the target device 730, or the feedback device 750 may be the same single device, and each of the input device 710, the target device 730, and the feedback device 750 may be a separate different device. The input device 710, the target device 730, and the feedback device 750 may each be one of a first type smart device, a second type smart device, a mobile device, and a small device.

For example, it may be assumed that the user 705 says “Turn on the TV”, and a smart speaker located near the user 705 receives an input corresponding to a speech of the user “Turn on the TV”.

In this example, the smart speaker operates as the input device 710 and transmits the input of the user 705 to the server 500. Since the input “Turn on the TV” is speech signal data, the server 500 analyzes the speech signal data and discerns that the input is to request activation of an operation of the TV, that is, TV “ON”.

The server 500 determines a device corresponding to the target device 730 turn “ON” the TV based on the input analysis, and determines a command to be executed by the corresponding device. In detail, the server 500 determines a control command of “ON” with respect to the target device 730 corresponding to the TV, and transmits the control command to “ON” to the actual TV.

For example, it may be assumed that there are two TVs, one in a living room and the other in a bed room, and a user did not provide a command explicitly indicating a predetermined TV.

The server 500 determines a TV closer to the input device 710 to be the target device 730, and transmits the control command of “ON” to the TV closer to the input device 710. The target device 730, that is, the TV closer to the input device 710, reports successful execution of the control command of “ON” to the server 500. The server 500 may also determine a TV closer to the user to be the target device 730 based on a location of the user detected through a mobile device of the user or a sensor present in the house.

The server 500 generates a response based on the report of the target device 730 and transmits the response to the feedback device 750. In this example, the smart speaker having received the speech of the user 705 operates as the feedback device 750 and provides a feedback of “TV is turned on” to the user 705. In a case in which there is a change in a state that may be recognized by the user without a separate feedback in response to execution of the control command at the target device 730 such as the TV, for example, in a case in which a screen is turned on or a sound is generated, the user may easily notice that the control command is executed through the screen or the sound. In this example, the server 500 may not determine a separate response, or determine a non-response as a feedback.

For example, it may be assumed that the TV corresponding to the target device 730 did not perfectly execute the control command of “ON”. This case may occur when the target device 730 is not connected to the server 500, or when the target device 730 is not controlled due to an unexpected error although the target device 730 is connected to the server 500.

In the former case, the server 500 determines that there is not a target device 730 to execute the control command, among devices connected to the server 500, and transmits a feedback of “TV is not connected” to the user 705. In the latter case, the server 500 receives an error report from the TV corresponding to the target device 730, generates a response based on the error report, and transmits the response to the user 705.

For example, it may be assumed that the user 705 desires to turn off a light in a bed room through a touch input with respect to an input interface of a smart phone of the user.

The server 500 converts the touch input into a command or a frame that a device, for example, the target device 730, may understand. The server 500 converts the touch input into a control command of “OFF” with respect to the light in the bed room.

The server 500 determines the light in the bed room to be the target device 730, and transmits the control command of “OFF” to the light in the bed room. The light in the bed room executes the control command of “OFF”, and reports successful execution of the corresponding control command to the server 500.

The server 500 determines the smart phone of the user 705 to be the feedback device 750, generates a feedback command to display information indicating the successful execution of the command through a display, and transmits the feedback command to the smart phone of the user 705. The smart phone of the user receiving the feedback command displays information indicating the successful execution of the corresponding command through the display.

In the above example, a case in which the user 705 controls an operation of another device through a predetermined device which is a smart phone has been described. However, embodiments are not limited thereto.

In an example, the user 705 directly controls the target device 730, without using a predetermined device. The user 705 directly controls the target device 730, and inputs a result of controlling the target device 730 into the server 500.

The server 500 updates a device connected to the server 500, a command executable by the connected device, and a state of the connected device based on a state of the target device 730 that is input directly by the user 705. In this example, the server 500 does not need to determine an action, and thus determines only a response as necessary, rather than determining an action.

To provide a personalized service of a predetermined user, the smart phone of the user 705 and a smart phone of another user each may respectively be connected through local area wireless communication and/or wired communication. In this example, the user 705 is assigned with a guest authority from the other user, and the user 705 operates the smart phone of the user 705 within the authority set by the other user.

For example, it may be assumed that the user 705 desires to turn on a TV of another user using a smart phone of the user 705.

When the user 705 says “Turn on the TV” to the smart phone of the user 705, the server 500 analyzes the input “Turn on the TV” based on a personalized service model that is specialized for the user 705, or the smart phone of the user 705, and transmits an action to turn on the TV of the other user which corresponds to the target device 730.

In this example, it may be assumed that the other user did not assign an authority over a turning-on operation to a user having a guest authority or to a smart phone of the user having guest authority.

Since the authority over the turning-on operation is not assigned with respect to an executable command for the TV which corresponds to the target device 730, the server 500 determines the corresponding command to be an inexecutable command and does not determine an action. Thus, the TV is not turned on, and the server 500 provides a feedback indicating that the TV is not turned on by the guest authority assigned to the user 705.

As described above, the server 500 provides an integrated service, for example, a personalized service or a common service, with respect to all devices connected to the server 500. Information for a personalized service of a user is shared through the server 500, and thus the server 500 assigns a continuity with respect to the personalized service of the user, and the user is provided with convenience from the continuity.

Further, through connection of a personalized model and a personalized service stored in the server 500, a smart device is controlled identically in a new region as well, and a personalized service such as content recommendation for each user is also provided conveniently.

In addition, small devices are controlled through a first type smart device such as a smart dock. The user controls a smart device and a small device through a single server 500.

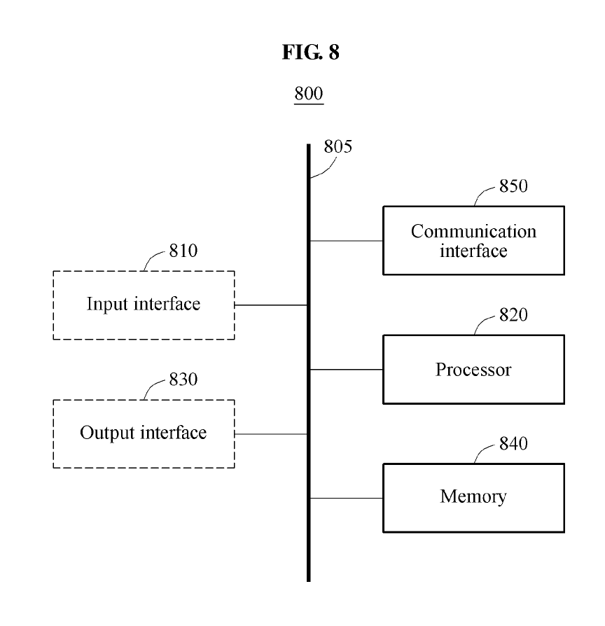

FIG. 8 is a block diagram illustrating an example of a smart device in accordance with an embodiment. Referring to FIG. 8, a smart device 800 may include a processor 820, a memory 840, and a communication interface 850. The smart device 800 further may include either or both an input interface 810 configured to receive an input and an output interface 830 configured to perform an action or a response. The input interface 810, the processor 820, the output interface 830, the memory 840 and the communication interface 850 communicate with each other through a communication bus 805.

The smart device 800 of FIG. 8 performs one of the operations, a combination thereof, or all operations described in relation to the smart devices and/or docking devices with reference to FIGS. 1 through 13.

For example, the input interface 810 receives an input. The processor 820 verifies whether there is a mobile device connected to the smart device 800, and determines a server to access to analyze the input based on a result of the verifying. The communication interface 850 transmits the input received through the input interface 810 to the server determined by the processor 820.

The processor 820 executes a program, and controls the smart device 800. Program codes to be executed by the processor 820 are stored in the memory 840. The memory 840 is a volatile memory or a non-volatile memory.

The memory 840 stores commands for the processor 820 to perform one of the processes or a combination thereof described with reference to FIGS. 1 through 13, when executed by the processor 820. Further, the memory 840 stores the server determined by the processor 820. In addition, the memory 840 may include information related to an authority assigned to each user and/or an authority over a command assigned to each user.

Although examples will be described further below, embodiments are not limited thereto. For example, the smart device 800 is a smart device that receives a first command from a first server which is preset to correspond to the smart device 800, and executes the first command. The smart device 800 is installed in a space for a first user, and configured to receive the first command from the first server corresponding to the first user and execute the first command. The “first command” is a command determined by the first server in response to an input of the first user, and may include, for example, both a control command for a target device to be controlled and a feedback command for a feedback device.

In this example, a second command is received from a second server corresponding to a second user of a mobile device through the communication interface 850. The “second command” is a command determined by the second server in response to an input of the second user, and may include, for example, both a control command for a target device to be controlled and a feedback command for a feedback device.

In this example, the processor 820 verifies whether the second user has an authority over the second command using the memory 840 of the smart device 800 or the first server. The processor 820 executes the second command based on a result of the verifying.

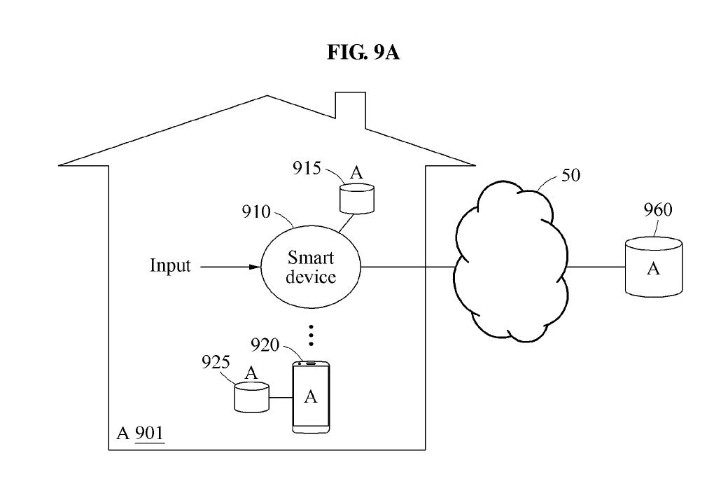

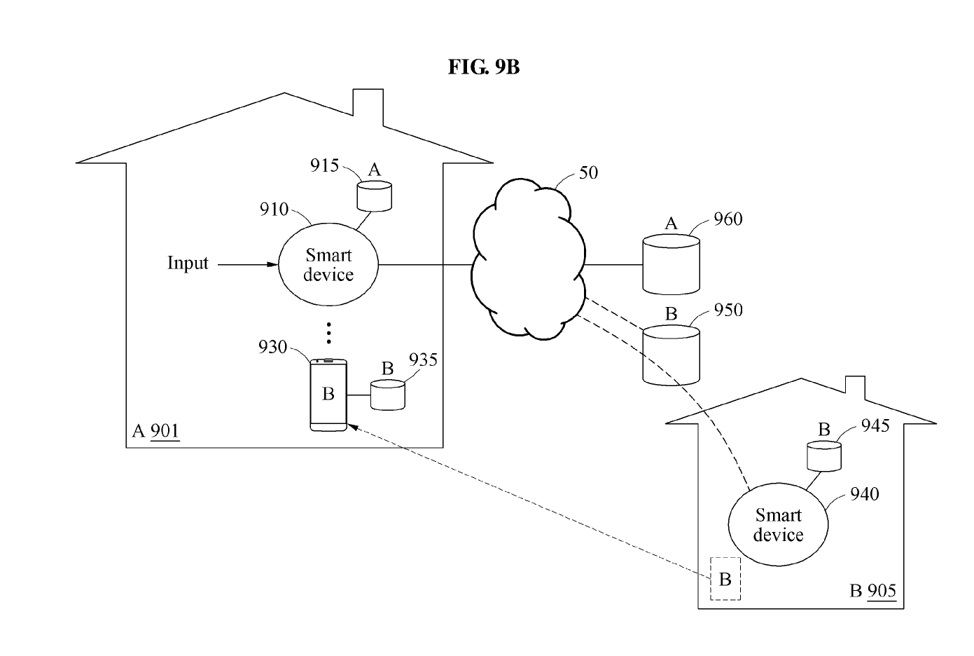

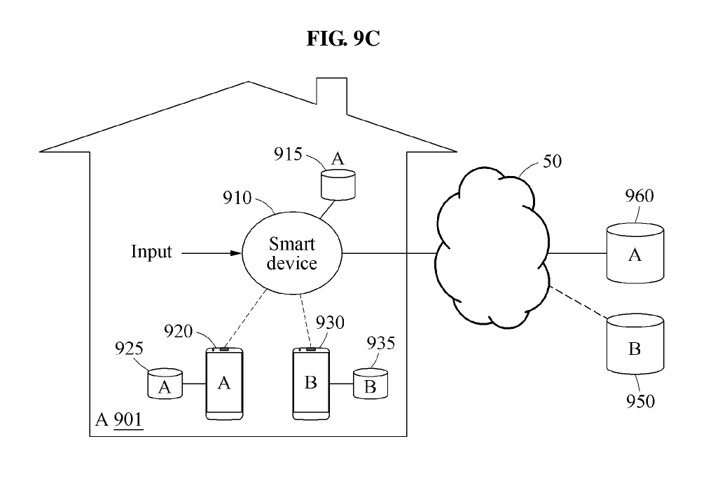

FIGS. 9A through 9C illustrate examples of scenarios in which a smart device determines a server to access in accordance with an embodiment. Referring to FIGS. 9A through 9C, a space 901 for a first user A, a smart device 910 installed in the space 901, a mobile device 920 of the first user A, first servers 915, 925, and 960 corresponding to the first user A, a space 905 for a second user B, a smart device 940 installed in the space 905, second servers 935, 945, and 950 corresponding to the second user B, and a mobile device 930 of the second user B are illustrated. The mobile device 930 of the second user B is moved from the space 905 for the second user B to the space 901 for the first user A.

Referring to FIG. 9A, a case in which the first user A is carrying the mobile device 920 of his/her own in the space 901 for the first user A is illustrated.

When an input is received at the smart device 910, the smart device 910 verifies whether there is a mobile device connected to the smart device 910. In response to verification that the mobile device 920 of the first user A is connected to the smart device 910, the smart device 910 determines a server corresponding to the mobile device 920 of the first user A to be a server to access. The smart device 910 transmits the input from the mobile device 920 to the first server 915, 925, or 960. In this example, the first server 915 is located in the space 901 for the first user A, and the first server 960 is located outside of the space 901 for the first user A. At least a portion of the first server 925 is included in the mobile device 920, or the first server 925 is the mobile device 920 itself.

The smart device 910 transmits the input of the mobile device 920 to the first server 915, 925, or 960, thereby providing a personalized service to the first user A of the mobile device 920.

Referring to FIG. 9B, a case in which the second user B carrying the mobile device 930 visits the first user A in the space 901 is illustrated.

When an input is received at the smart device 910, the smart device 910 determines the preset first server 915 or 960 to be a server to access to analyze the input, and transmits the input to the first server 915 or 960 in a case in which there is not a mobile device connected to the smart device 910. The first server 915 or 960 analyzes the input. The first server 915 is located in the space 901 for the first user A, and the first server 960 is located separately outside of the space 901 for the first user A. As described above, the first user A is a predetermined user or an undetermined user.

In this example, though, the second user B visits the first user A in the space 901, and uses the smart device 910 installed in the space 901. The mobile device 930 of the second user B moved into the space 901 is connected to the smart device 910 through wired docking or wireless pairing.

In response to verification that there is a mobile device 930 connected to the smart device 910, the smart device 910 determines the second server 945, 935, or 950 corresponding to the mobile device 930 to be a server to access, and transmits the input from the mobile device 930 to the second server 945, 935, or 950. In this example, the second server 945 is located in the space 905 for the second user B, and the second server 950 is located outside of the space 901 for the first user A and the space 905 for the second user B. The second server 935 is included in the mobile device 930.

The smart device 910 transmits the input of the mobile device 930 to the second server 945, 935, or 950, thereby providing a personalized service to the second user B of the mobile device 930.

In a case in which the mobile device 930 is connected to the smart device 910 through wireless pairing, the smart device 910 requests the second server 935 to analyze the input through wireless pairing, or receives a command from the second server 935. The smart device 910 is connected to the second server 935 through the network 50 to request the second server 935 to analyze the input, or receive a command from the second server 945.

Referring to FIG. 9C, a case in which the mobile device 920 of the first user A and the mobile device 930 of the second user B coexist in the space 901 for the first user A is illustrated. In this example, both the mobile device 920 of the first user A and the mobile device 930 of the second user B are connected to the smart device 910.

When an input is received at the smart device 910, the smart device 910 verifies there is a mobile device connected to the smart device 910.

In response to verification that both the mobile device 920 of the first user A and the mobile device 930 of the second user B are connected to the smart device 910, the smart device 910 transmits the input to servers corresponding to the connected mobile devices 920 and 930, that is, the first servers 915, 925 and 960, and the second servers 935 and 950.

Each server receiving the input from the smart device 910 processes an input from each user by analyzing or verifying a user of each corresponding server or a user of a mobile device through which the input is provided through an authentication function of an input analyzer in the server.

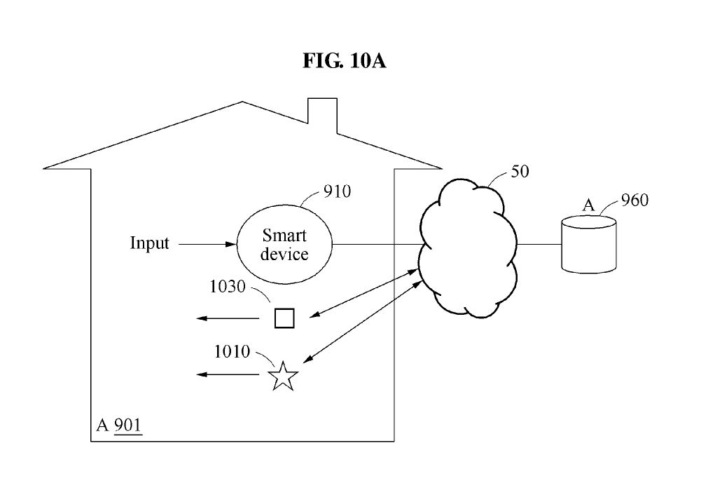

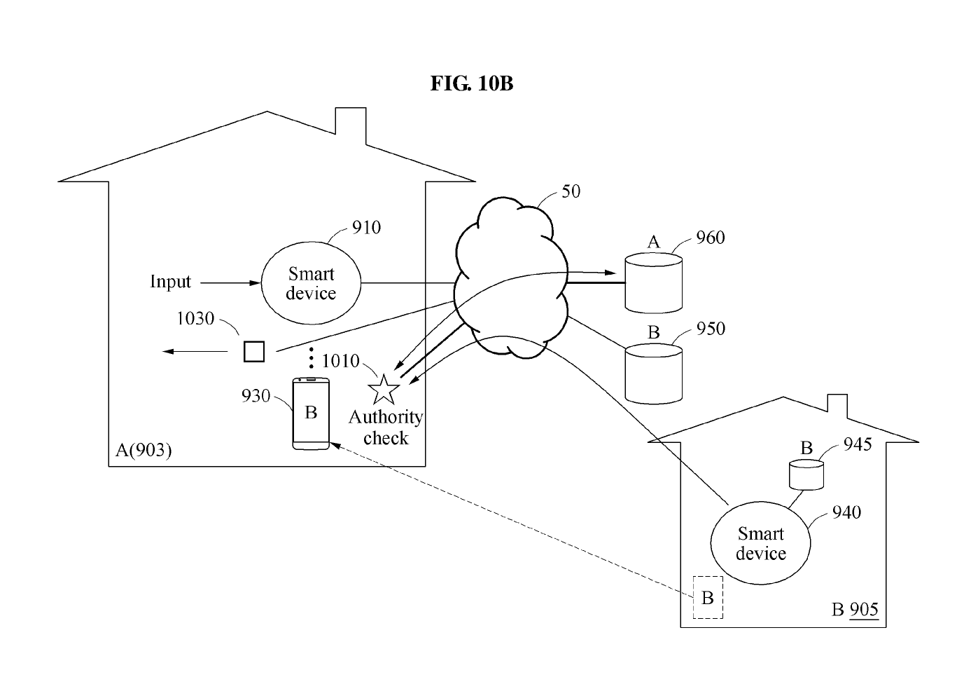

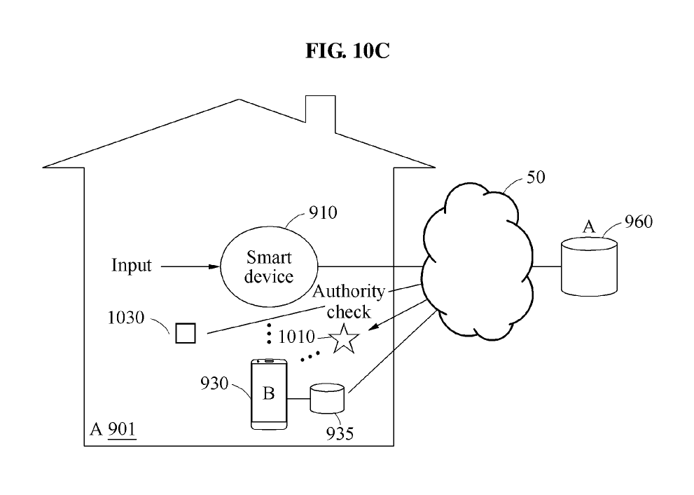

FIGS. 10A through 100 illustrate examples of various scenarios in which a smart device executes a command from a server in accordance with an embodiment. Referring to FIG. 10A, a process of executing a command of the first server 960 by a target device 1010 to be controlled and/or a feedback device 1030 in a case in which an input of a first user A is transmitted to the first server 960 through the smart device 910 is illustrated. For ease of description, the smart device 910, the target device 1010, and the feedback device 1030 are illustrated separately. However, in an example, two or more of the smart device 910, the target device 1010, and the feedback device 1030 may be the same device.

For example, it may be assumed that the input of the first user A is transmitted to the first server 960 located outside of the space 901 for the first user A through the smart device 910.

The first server 960 determines the target device 1010 corresponding to the input of the first user A by analyzing the input based on a corresponding database, and generates a first command to control the target device 1010. The first command generated by the first server 960 is transmitted to the target device 1010 through the network 50. The target device 1010 reports a result of executing the first command to the first server 960 through the network 50.

The first server 960 determines the feedback device 1030 based on the result of executing the first command, and generates a second command for a feedback through the feedback device 1030. The first server 960 transmits the second command to the feedback device 1030 through the network 50. The feedback device 1030 feeds back the result of executing the first command to the first user A based on the second command.

A process of executing a command transmitted from the first server 960 by the target device 1010 and the feedback device 1030 in a case in which the input of the first user A is received at the smart device 910 connected to a mobile device of the first user A is as follows.

When the input of the first user A is received at the smart device 910, the smart device 910 transmits the input to the first server 960 corresponding to the mobile device.

The first server 960 determines the target device 1010 corresponding to the input of the first user A by analyzing the input of the first user A based on a corresponding database, and generates a second command to control the target device 1010. The first server 960 transmits the second command to the target device 1010 through the network 50. In this example, the target device 1010 is a smart device or a small device located in the space 901 for the first user A.

The target device 1010 receiving the second command checks an authority of the first user A by inquiring about whether the first user A has an authority over the second command using the first server 960. The target device 1010 checks the authority of the first user A by verifying whether the first user A has the authority over the second command from a memory. The target device 1010 executes the second command in response to verification that the first user A has the authority over the second command.

The target device 1010 feeds back a result of executing the second command to the first server 960. The first server 960 receiving the result of executing the second command determines the feedback device 1030 to execute a second feedback command, and transmits the second feedback command to the feedback device 1030. Similar to the target device 1010, the feedback device 1030 also checks whether there is an authority of feedback for the first user A, and provides a feedback to the first user A.

Referring to FIG. 10B, a process of executing a command of the second server 950 or 945 by the target device 1010 and the feedback device 1030 in a case in which an input of the second user B is received at the smart device 910 connected to the mobile device 930 of the second user B is illustrated.

When the input of the second user B is received at the smart device 910, the smart device 910 transmits the input to the second server 950 or 945 corresponding to the mobile device 930, as described with reference to FIG. 9B.

The second server 950 or 945 determines the target device 1010 corresponding to the input of the second user B by analyzing the input of the second user B based on a corresponding database, and generates a second command to control the target device 1010. The second server 950 or 945 transmits the second command to the target device 1010 through the network 50. In this example, the target device 1010 is a smart device or a small device located in the space 901 for the first user A.

The target device 1010 receiving the second command checks an authority of the second user B by inquiring about whether the second user B has an authority over the second command using the first server 960. The target device 1010 checks the authority of the second user B by verifying whether the second user B has the authority over the second command from a memory. The target device 1010 executes the second command in response to verification that the second user B has the authority over the second command.

The target device 1010 feeds back a result of executing the second command to the second server 950 or 945. The second server 950 or 945 receiving the result of executing the second command determines the feedback device 1030 to execute a second feedback command, and transmits the second feedback command to the feedback device 1030. Similar to the target device 1010, the feedback device 1030 also checks whether there is an authority of feedback for the second user B, and provides a feedback to the second user B.

Referring to FIG. 100, a case in which at least a portion of the second server 935 is included in the mobile device 930 of the second user B is illustrated.

When an input of the second user B is received at the smart device 910 connected to the mobile device 930, the smart device 910 transmits the input to the second server 935 corresponding to the mobile device 930, as described with reference to FIG. 9B.

The second server 935 transmits the second command to the target device 1010 determined by analyzing the input. In this example, the second server 935 transmits the second command through the network 50. In a case in which the mobile device 930 and the target device 1010 are connected through a local area communication network, the second server 935 transmits the second command through the local area communication network.

The target device 1010 receiving the second command checks an authority of the second user B by inquiring of the first server 960 about whether the second user B has an authority over the second command through the network 50. As described above, the authority check performed by the target device 1010 is applied identically in a case in which the feedback device 1030, rather than the target device 1010, executes a feedback command.

FIG. 11 is a diagram illustrating an example of a method of feeding back a result of executing a control command for each user by a smart device in accordance with an embodiment. Referring to FIG. 11, a smart refrigerator 1110 is illustrated.

For example, it may be assumed that a user A of a mobile device 1130 says “Show me the inside of the refrigerator” to the smart refrigerator 1110 placed in a house of the user A.

The smart refrigerator 1110 transmits a voice input of “Show me the inside of the refrigerator” to a server A′ corresponding to the user A, and displays a compartment of the smart refrigerator 1110 that the user A often uses on a screen of the smart refrigerator 1110 based on a control command received from the server A′, for example, to capture and display the third compartment of the refrigerator. In this example, the server A′ stores information indicating that the user A often uses the third compartment of the smart refrigerator 1110 based on a use pattern of the user A that is discerned from a continuous use of the user A, and provides a personalized service to the user A based on the stored information. In this example, the server N is the mobile device 1130.

The smart refrigerator 1110 displays an image of the third compartment on the screen of the smart refrigerator 1110. In this example, a result of executing the control command acts as a feedback command to inform the user A of the result of executing the control command, and the server A′ does not determine a separate feedback command and a feedback device.

For example, it may be assumed that a user B of a mobile device 1150 says “Show me the inside of the refrigerator” to the smart refrigerator 1110. The smart refrigerator 1110 transmits a voice input of “Show me the inside of the refrigerator” of the user B to a server B′ corresponding to the user B. The server B′ receiving the voice input of the user B generates a control command, for example, to capture and display the first compartment of the refrigerator, based on personalized information of the user B. The smart refrigerator 1110 receiving the control command displays an image of the first compartment on the screen of the smart refrigerator 1110. In this example, the server B′ is the mobile device 1150.

As described above, a smart device executes a control command or a feedback command in a different manner with respect to the same input.

Hereinafter, examples of providing a personalized service using various smart devices and small devices will be described.

A user inspects a condition of house using a mobile device outside the house, or controls connected devices, for example, smart devices and/or small devices, in the house through a server.

For example, when the user carrying the mobile device enters the house, a home server or a smart dock in the house detects a location of the user through the mobile device, and automatically performs local area wireless connection with the mobile device or checks physical docking with respect to the smart dock. Here, the server and the smart dock are the first server and the smart dock, respectively, described with reference to FIGS. 1 through 11. However, embodiments are not limited thereto.

The server or the smart dock detecting the entry of the user prepares for communication with interactive devices, for example, a smart speaker, a smart home robot, and a smart TV, using a voice or a physical touch of the user. In this example, smart devices or small devices unable to be connected directly to a server since the Internet connection is unavailable are connected to the server through local area wireless connection with the smart dock capable of the Internet connection.

The user transmits a conversation and an input, that is, a command, to a home server through the interactive devices or the smart dock at any location in the house, and is provided with a personalized service for the user. Hereinafter, examples of providing a personalized service using various interactive devices will be described.

In an example, a smart phone may operate as a main device of a user in providing a personalized PAS. The smart phone receives an input of the user and executes a command, is used to detect a location of the user, and/or is used for connection to a personalized server.

In an example, the smart phone miniaturizes and may include a function of the server described above, thereby controlling all devices connected to the smart phone. In this example, the smart phone executes a portion of commands instead of the server, without connection to the server.

Further, the smart phone is used as a main device of the user to provide a personalized PAS. When the user carrying the smart phone visits a new place, the smart phone of the user is connected to another smart device located in the new place. Through connection to a personalized server through the smart phone, the smart device provides the personalized service to the user of the smart phone within an operation authority allowed by a user or a manager of the new place. The personalized service may include, for example, an artificial personal assistant (APA) model specialized for the user of the smart phone, recommending personalized content, and importing personal settings.

In an example, a smart dock is a device configured to connect a small device or modules installed or disposed in a house or vehicle to a server. The server is a server configured to provide a PAS, for example, the server described with reference to FIGS. 4 through 11. However, embodiments are not limited thereto.

The small device or modules at least include a local area wireless communication module so as to be connected to the smart dock. The smart dock verifies whether a user is proximate to the smart dock through local area wireless communication or physical docking with a smart phone of a user.

In response to verification that the user is proximate to the smart dock, the smart dock transmits an input wait signal to small devices connected to the smart dock, thereby enabling the small devices to receive an input of the user. In an example, in a case in which the smart dock is unable to communicate with the server, the smart dock solves the issue through communication with a server (for example, a module) miniaturized and included in the smart phone.

In an example, a personal service robot recognizes an image input through a camera provided therein, and/or recognizes a voice input through a microphone provided therein, thereby receiving an input of a user. For example, the personal service robot recognizes a motion or a gesture of the user through the camera, or recognizes an emotion of the user from a face and/or a voice of the user. The personal service robot also performs situation recognition or environment recognition by capturing image information such as a home environment. Further, the personal service robot performs an alarming function and control of home appliances through interoperation with a smart phone.

The personal service robot is used as a main device of the user to provide a PAS, or operates as the smart dock described above or a communication hub.

In an example, a smart TV or a smart set-top box operates as a smart device.

The smart TV or the smart set-top box executes a command, for example, from a device control command of “Turn on the TV” to a video on demand (VOD) service control command of “find the movie OOO”.

For example, it may be assumed that a user B visits a house of a user A who is a main user or a manager.

In a case in which a voice of “recommend a movie” is input by the user A, the smart TV or the smart set-top box analyzes the input through a server A′ corresponding to the user A, and provides a recommendation service to the user A based on movies that the user A has enjoyed.

Unlike the above case, in a case in which a smart phone of the user B is connected to the smart TV or the smart set-top box, and a voice of “recommend a movie” is input by the user B, the smart TV or the smart set-top box analyzes the input through a server B′ corresponding to the user B, and provides a recommendation service based on movies that the user B has enjoyed.

An operation control with respect to a guest user is determined differently based on an authority assigned by the user A being a main user to the guest user B. A personalized service activated through such connection is applied identically to a public facility such as a hotel.

In a case in which a voice of the user A is input although the smart phone of the user B is connected to the smart TV or the smart set-top box, an input analyzer of the server B′ fails in user authentication. The smart TV or the smart set-top box also transmits the voice of the user A to the server A′ to process the input of the user A.

In an example, a smart speaker operates a smart device, and may include, for example, a wired/wireless communication interface for connection between a server and a smart dock, a microphone configured to receive a user input, and a speaker configured to provide a feedback or a voice service.

The smart speaker is connected directly to the server, or connected to the server through communication with the smart dock. The smart speaker communicates with the smart dock via the server, and performs local area wireless communication directly with the smart dock.

When receiving information indicating that a user is in the house through the server or the smart dock, the smart speaker prepares for an input or an output through the microphone or the speaker. In response to verification that an input of the user is received through the microphone, the smart speaker transmits the received input to the server. The smart speaker performs an operation corresponding to a command of the server, for example, playing music or reporting weather, irrespective of a device from which the input is received.

In an example, unlike the smart speaker, a mini speaker is a speaker unable to be connected directly to a server. The mini speaker is connected to a smart dock through local area wireless communication, and waits for an input of a user in response to reception of an input wait signal from the smart dock.

When the input of the user is received, the mini speaker transmits the input of the user and/or a device identifier of the mini speaker to the smart dock. The smart dock transmits the input of the user and/or the device identifier to the server. The server analyzes the input of the user and/or the device identifier, and transmits a control command to be executed in response to the input to a target device to be controlled.

For example, when the user says “Turn on the TV”, the mini speaker receiving the speech of the user transmits the speech of the user to the smart dock, and the smart dock transmits the speech of the user to the server. The server analyzes the speech, and transmits a control command to a smart TV which is the target device. The smart TV receiving the control command completes execution of the control command by being turned on.

In general, it is difficult to include an Internet connection module or a communication interface for direct connection to a server in a mini table lamp and/or a general light due to a structure thereof. However, in an example, a mini table lamp and/or general light may include a small local area communication module, thereby being connected to a smart dock. When a voice input of “Turn off the light” is received from a smart phone or a smart speaker, a server transmits a command to the mini table lamp and/or the general light based on the voice input, and the corresponding device executes the command.

In an example, the user turns off a light by directly switching off the light without a voice input of “Turn off the light”. In this example, the mini table lamp and/or the general light transmits a state thereof to the server each time the state changes, for example, each time the mini table lamp and/or the general light is turned on or off, thereby enabling the server to discern and manage the state thereof.

For example, it may be assumed that a user A having set a light alarm at 6:00 a.m. at home stays at accommodation such as a hotel. A smart phone of the user A is connected to a smart dock to enable the smart dock to access a server of the user A and obtain setting information with respect to the light alarm. The smart dock applies the setting information with respect to the light alarm for the user A to a mini table lamp and/or a general light in the hotel. Through this, the user A is automatically provided with a service of providing a light alarm at 6:00 a.m. in the hotel, like at home.

In an example, a smart car may include a smart dock provided therein. The smart dock operates similarly as a general smart dock, except for that devices to be docked with the smart dock are in-vehicle devices or vehicular devices.

In a case of a general vehicle not including an in-vehicle smart dock, an external smart dock is installed in the vehicle to operate as a smart dock. In this example, as necessary, vehicular parts are replaced with small devices to be connected to the smart dock.

For example, when an input is received from a display or a microphone provided in the vehicle, the smart dock is connected to a server to control a navigation system, an audio system, an air conditioner, seat heating wires, and the smart car itself. However, in view of necessity for safety assurance and prompt control and response due to characteristics of the vehicle, commands related to driving of the smart car require quick actions. Thus, a separate server for vehicle management is provided in the smart car, independently from a server configured to provide a personalized service.

As an example of the personalized service, when a smart phone of a user A is connected to the smart car for a service such as car sharing, the smart car obtains information related to the user A from a server for the user A. Based on the information related to the user A, the smart car provides a service, for example, driver seat setting for the user A, driving environment setting through an analysis of driving pattern of the user A, and personal settings of a car audio system.

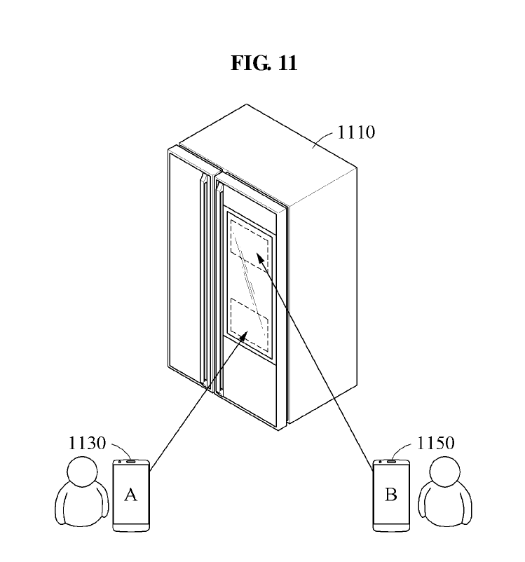

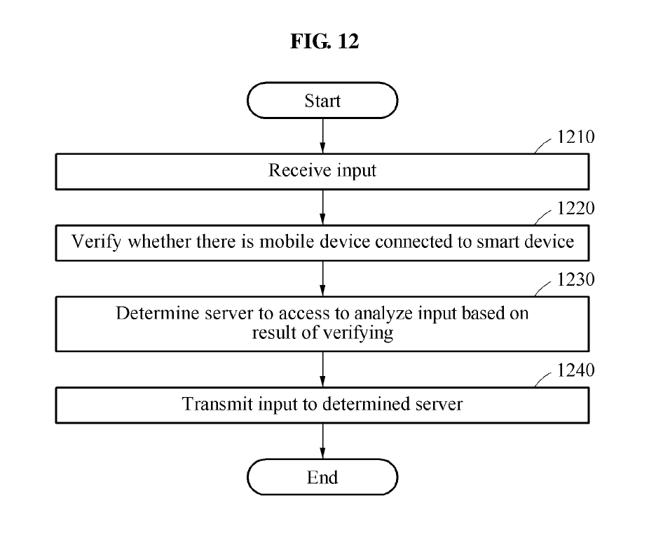

FIG. 12 is a flowchart illustrating an example of an operating method of a smart device in accordance with an embodiment. Referring to FIG. 12, in operation 1210, a smart device receives an input. The smart device receives the input through an input interface of the smart device. The smart device receives the input from a small device connected to the smart device.

In operation 1220, the smart device verifies whether there is a mobile device connected to the smart device. The smart device verifies whether there is a mobile device connected to the smart device through wired docking or whether there is a mobile device connected to the smart device through wireless pairing. In response to verification that there is a mobile device connected to the smart device, the smart device activates a small device connected to the smart device and operating in a sleep mode.

In operation 1230, the smart device determines a server to access to analyze the input based on a result of the verifying in operation 1220. The server determines a target device to be controlled that corresponds to the received input by analyzing the input based on a corresponding database. The server generates a first command to control the target device. Further, the server determines a feedback device based on a result of executing the first command, and generates a second command for a feedback through the feedback device.

In response to verification that there is not a mobile device connected to the smart device, the smart device determines a first server preset to correspond to the smart device to be the server to access. In response verification that there is a mobile device connected to the smart device, the smart device determines a second server corresponding to the mobile device to be the server to access. The second server analyzes the input to provide a personalized service to a user of the mobile device.

In operation 1240, the smart device transmits the received input to the determined server.

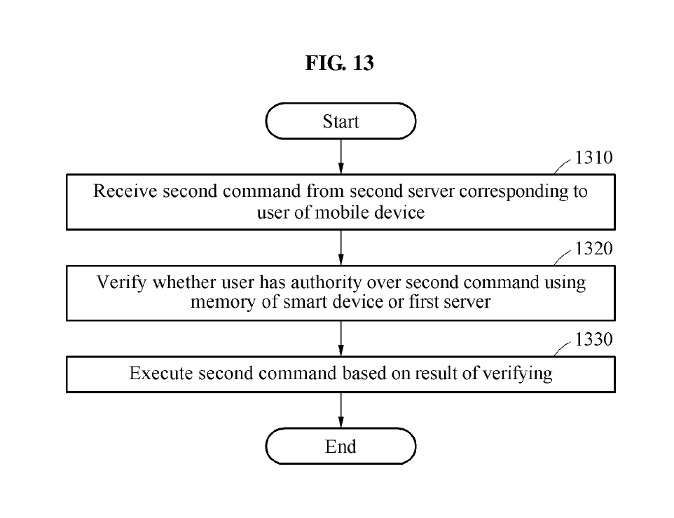

FIG. 13 is a flowchart illustrating an example of an operating method of a smart device in accordance with an embodiment. A smart device is a smart device configured to receive a first command from a first server preset to correspond to the smart device and execute the first command.

Referring to FIG. 13, in operation 1310, the smart device receives a second command from a second server corresponding to a user of a mobile device. Here, the first server corresponds to a space in which the smart device is installed, and the second server corresponds to the user of the mobile device.

In operation 1320, the smart device verifies whether a second user has an authority over the second command using a memory of the smart device or the first server.

In operation 1330, the smart device executes the second command based on a result of the verifying in operation 1320. The second command may include a second control command determined by the second server in response to an input of the second user. The second control command may include, for example, at least one of a control command to control the smart device or a control command to control a small device connected to the smart device. The second command may include a second feedback command determined by the second server based on a result of executing a control command corresponding to the input of the second user. The second feedback command may include, for example, at least one of a feedback command for a feedback through the smart device or a feedback command for a feedback through the small device connected to the smart device.

The smart device feeds back a result of executing the second command to the second server after the second command is executed in operation 1330.

The mobile device 110, docking device 130, smart device 410, mobile device 430, first server 420, second server 440, network 50, server 500, database 550, system 600, smart device 610, mobile device 630, smart device 650, small device(s) 670, input device 710, target device 730, feedback device 750, smart device 800, input interface 810, processor 820, output interface 830, memory 840, smart device 910, mobile device 920, first servers 915, 925, and 960, smart device 940, second servers 935, 945, and 950, mobile device 930, target device 1010, feedback device 1030, smart refrigerator 1110, mobile device 1130, and mobile device 1150 of FIGS. 1-13 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor implemented operating method of a mobile device, the operating method comprising:
verifying whether the mobile device is docked with a docking device while the mobile device is performing a personal assistance service (PAS); and
continuously providing the PAS being performed using the docking device in response to the verifying indicating that the mobile device is docked with the docking device while the mobile device is performing the PAS.

2. The operating method of claim 1, wherein:
the PAS comprises any one or any combination of any two or more of viewing, listening to, subscribing, searching, and recommending information; and
the information comprises any one or any combination of any two or more of weather and news, scheduling, making a call, recommending personalized content, importing personal settings, listening to voice information including a sound source, and object control.

3. The operating method of claim 1, wherein the continuously providing the PAS being performed comprises using an input/output interface of the docking device or an input/output interface of another device controlled by the docking device.

4. The operating method of claim 1, further comprising:
providing the PAS in a first manner in response to the verifying indicating that the mobile device is not docked with the docking device,
wherein the continuously providing of the PAS being performed comprises providing the PAS in a second manner different from the first manner while maintaining continuity of the PAS in response to the verifying indicating that the mobile device is docked with the docking device while the mobile device is performing the PAS.

5. The operating method of claim 1, further comprising:
providing the PAS based on a hardware performance of the mobile device in response to the verifying indicating that the mobile device is not docked with the docking device while the mobile device is performing the PAS,
wherein the continuously providing of the PAS being performed comprises:
identifying a hardware performance of the docking device or another device controlled by the docking device,
changing a quality of the PAS based on the hardware performance of the docking device or the other device controlled by the docking device, and
providing the quality-changed PAS while maintaining continuity of the PAS.

6. A processor implemented operating method of a docking device, the operating method comprising:
verifying whether a mobile device is docked with the docking device; and
continuously providing a personal assistance service (PAS) being performed by the mobile device in response to the verifying indicating that the mobile device is docked with the docking device.

7. The operating method of claim 6, wherein:
the continuously providing comprises providing the PAS through at least one function included in the docking device; and
the PAS was provided through at least one function included in the mobile device before docking with the docking device.

8. The operating method of claim 6, wherein the continuously providing comprises:
receiving user information related to a user of the mobile device from the mobile device; and
providing the PAS based on the user information.

9. The operating method of claim 8, wherein the user information comprises any one or any combination of any two or more of a language used by the user, personal information of the user, a use pattern of the user in the mobile device corresponding to an input of the user, setting information of the mobile device, preference information of the user, vocal characteristic information of the user, and image characteristic information of the user.

10. The operating method of claim 6, wherein the continuously providing comprises:
receiving vocal characteristic information of a user of the mobile device from the mobile device;
performing voice recognition with respect to a received voice based on the vocal characteristic information; and
continuously providing the PAS based on a result of the voice recognition.

11. The operating method of claim 10, wherein:
the performing comprises analyzing, based on the vocal characteristic information, whether the received voice is to request the PAS; and
the PAS was provided by the mobile device before docking with the docking device.

12. The operating method of claim 11, wherein:
the continuously providing comprises providing, in response to the analyzing determining that the received voice is to request a news viewing service, the news viewing service through at least one function included in the docking device; and
the news viewing service was provided by the mobile device before the mobile device was docked with the docking device.

13. The operating method of claim 11, wherein:
the continuously providing comprises:
verifying, in response to the analyzing determining that the received voice is to request a news viewing service, whether the news viewing service is providable through at least one function included in the docking device, and
providing a news listening service in response to the verifying indicating that the news viewing service is not providable through the at least one function included in the docking device; and
the news viewing service was provided by the mobile device before docking with the docking device.

14. The operating method of claim 11, further comprising:
receiving setting information of the mobile device from the mobile device,
wherein the continuously providing comprises:
adjusting, in response to the analyzing determining that the received voice is to request the PAS, settings for the docking device to correspond to the setting information of the mobile device, and
providing the PAS based on the adjusted settings for the docking device, and
wherein the PAS was provided by the mobile device before docking with the docking device.

15. The operating method of claim 6, wherein the continuously providing comprises:
receiving food preference information of a user of the mobile device from the mobile device;
processing information related to food stored in a food storage linked with the docking device based on the food preference information of the user of the mobile device; and
providing the processed information to the user.

16. A processor implemented operating method of a smart device, the operating method comprising:
receiving an input;
verifying whether a mobile device is connected to the smart device;
determining, based on a result of the verifying, a server to access to analyze the input; and
transmitting the input to the determined server.

17. The operating method of claim 16, wherein the receiving comprises either one or both of:
receiving the input through an interface of the smart device; and
receiving the input from a small device connected to the smart device.

18. The operating method of claim 16, wherein the input comprises any one or any combination of any two or more of a voice input, a gesture input, a motion input, an image input, and a touch input.

19. The operating method of claim 16, wherein the smart device is one or more smart devices that comprises any one or any combination of any two or more of a home appliance, an audio system, a speaker, a robot vacuum cleaner, a personal service robot, a portable communication device, a dock, and an automobile.

20. The operating method of claim 16, wherein the determining comprises:
determining, in response to the verifying indicating that the mobile device is not connected to the smart device, a first server corresponding to the smart device to be the server to access; and
determining, in response to the verifying indicating that the mobile device is connected to the smart device, a second server corresponding to the mobile device to be the server to access.

21. The operating method of claim 20, wherein:
the smart device is installed in a space for a predetermined user; and
the first server is configured to be set as a server corresponding to the space for the predetermined user, and analyze the input to provide a personalized service to the predetermined user.

22. The operating method of claim 20, wherein:
the smart device is installed in a space for a predetermined user; and
the first server is configured to be set as a server corresponding to the space for the predetermined user, and analyze the input to provide a common service in the space.

23. The operating method of claim 20, wherein the second server is configured to analyze the input to provide a personalized service to a user of the mobile device.

24. The operating method of claim 23, wherein the personalized service comprises any one or any combination of any two or more of a language used by the user, personal information of the user, a use pattern of the user with respect to a target device to be controlled that corresponds to the input, setting information of the target device, and preferred content of the user.

25. The operating method of claim 16, wherein the verifying comprises either one or both of:
verifying whether there is a mobile device connected to the smart device through wired docking; and
verifying whether there is a mobile device connected to the smart device through wireless pairing.

26. The operating method of claim 16, wherein the server is configured to:
determine a target device to be controlled that corresponds to the input by analyzing the input based on a corresponding database; and
generate a first command to control the target device.

27. The operating method of claim 26, wherein the server is configured to:
determine a feedback device based on a result of executing the first command; and
generate a second command for a feedback through the feedback device.

28. The operating method of claim 16, further comprising:
activating, in response to the verifying indicating that the mobile device is connected to the smart device, a small device operating in a sleep mode and connected to the smart device.

29. A processor implemented operating method of a smart device, the operating method comprising:
receiving a second command from a second server corresponding to a user of a mobile device;
verifying whether the user has an authority over the second command using a memory of the smart device or the first server; and
executing the second command based on a result of the verifying,
wherein the second command is different than a first command from a first server corresponding to the smart device for execution of the first command by the smart device.

30. The operating method of claim 29, wherein the first server corresponds to a space in which the smart device is installed, and
the second server corresponds to the user of the mobile device.

31. The operating method of claim 29, wherein the second command comprises a second control command determined by the second server in response to an input of the user, and
the second control command comprises at least one of a control command to control the smart device or a control command to control a small device connected to the smart device.

32. The operating method of claim 31, further comprising:
feeding back a result of executing the second command to the second server.

33. The operating method of claim 31, wherein the second command comprises a second feedback command determined by the second server based on a result of executing a control command corresponding to an input of the user, and
the second feedback command comprises at least one of a feedback command for a feedback through the smart device or a feedback command for a feedback through a small device connected to the smart device.

34. A non-transitory computer-readable medium storing instructions that, when executed by a processor, cause the processor to perform the method of claim 1.
